(19) United States
(12) Patent Application Publication
(10) Pub. No.: US 2025/0200298 A1
(43) Pub. Date: Jun. 19, 2025

(54) LANGUAGE MODEL SPECIALIZATION VIA PROMPT ANALYSIS

(71) Applicant: Cisco Technology, Inc., San Jose, CA (US)

(72) Inventors: Myungjin Lee, Bellevue, WA (US); Gaowen Liu, Austin, TX (US); Ramana Rao V.R. Kompella, Foster City, CA (US)

(21) Appl. No.: 18/544,609

(22) Filed: Dec. 19, 2023

(51) Int. Cl. G06F 40/40

(52) U.S. Cl. CPC G06F 40/40

(57) ABSTRACT

In one implementation, a device obtains prompt-response pairs of prompts for input to a language model and their corresponding responses from the language model. The device classifies each of the prompt-response pairs as relating to one or more tasks. The device trains a specialized language model using the prompt-response pairs related to a particular task. The device causes the specialized language model to be deployed for use to perform the particular task.

### TECHNICAL FIELD

The present disclosure relates generally to artificial intelligence and, more particularly, to language model specialization via prompt analysis.

### BACKGROUND

The recent breakthroughs in large language models (LLMs), such as ChatGPT and GPT-4, represent new opportunities across a wide spectrum of industries. More specifically, the ability of these models to follow instructions now allow for interactions with tools (also called plugins) that are able to perform tasks such as searching the web, executing code, etc. In addition, agents can be written to perform complex tasks by chaining multiple calls to one or more LLMs.

While LLMs are quite capable of performing a myriad of tasks, they are also typically considerably large and complex, making them ill-suited for deployment to singular devices for execution. Thus, in many Internet of Things (IoT) and other such deployments, LLMs are precluded from being executed at the edge, instead being cloud-hosted. This reliance on a cloud-hosted LLM means both increased Wide Area Network (WAN) bandwidth utilization, as well as increased processing latency, as traffic needs to be conveyed between the local site and the cloud. One observation herein, though, is that many IoT and other deployments do not require the capabilities of a full-scale LLM and that they only need to perform a relatively small, discrete set of tasks.

### BRIEF DESCRIPTION OF THE DRAWINGS

The implementations herein may be better understood by referring to the following description in conjunction with the accompanying drawings in which like reference numerals indicate identically or functionally similar elements, of which:

FIG. 1 illustrates an example computer network;

FIG. 2 illustrates an example network device/node;

FIG. 3 illustrates an example architecture for language model specialization via prompt analysis; and

FIG. 4 illustrates an example simplified procedure for language model specialization via prompt analysis.

### DESCRIPTION OF EXAMPLE IMPLEMENTATIONS

### Overview

According to one or more implementations of the disclosure, a device obtains prompt-response pairs of prompts for input to a language model and their corresponding responses from the language model. The device classifies each of the prompt-response pairs as relating to one or more tasks. The device trains a specialized language model using the prompt-response pairs related to a particular task. The device causes the specialized language model to be deployed for use to perform the particular task.

### DESCRIPTION

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. Other types of networks, such as field area networks (FANs), neighborhood area networks (NANs), personal area networks (PANs), etc. may also make up the components of any given computer network.

In various implementations, computer networks may include an Internet of Things network. Loosely, the term “Internet of Things” or “IT” (or “Internet of Everything” or “IoE”) refers to uniquely identifiable objects (things) and their virtual representations in a network-based architecture. In particular, the IoT involves the ability to connect more than just computers and communications devices, but rather the ability to connect “objects” in general, such as lights, appliances, vehicles, heating, ventilating, and air-conditioning (HVAC), windows and window shades and blinds, doors, locks, etc. The “Internet of Things” thus generally refers to the interconnection of objects (e.g., smart objects), such as sensors and actuators, over a computer network (e.g., via IP), which may be the public Internet or a private network.

Often, IoT networks operate within a shared-media mesh networks, such as wireless or wired networks, etc., and are often on what is referred to as Low-Power and Lossy Networks (LLNs), which are a class of network in which both the routers and their interconnect are constrained. That is, LLN devices/routers typically operate with constraints, e.g., processing power, memory, and/or energy (battery), and their interconnects are characterized by, illustratively, high loss rates, low data rates, and/or instability. IoT networks are comprised of anything from a few dozen to thousands or even millions of devices, and support point-to-point traffic (between devices inside the network), point-to-multipoint traffic (from a central control point such as a root node to a subset of devices inside the network), and multipoint-to-point traffic (from devices inside the network towards a central control point).

Edge computing, also sometimes referred to as “fog” computing, is a distributed approach of cloud implementation that acts as an intermediate layer from local networks (e.g., IoT networks) to the cloud (e.g., centralized and/or shared resources, as will be understood by those skilled in the art). That is, generally, edge computing entails using devices at the network edge to provide application services, including computation, networking, and storage, to the local nodes in the network, in contrast to cloud-based approaches that rely on remote data centers/cloud environments for the services. To this end, an edge node is a functional node that is deployed close to IoT endpoints to provide computing, storage, and networking resources and services. Multiple edge nodes organized or configured together form an edge compute system, to implement a particular solution. Edge nodes and edge systems can have the same or complementary capabilities, in various implementations. That is, each individual edge node does not have to implement the entire spectrum of capabilities. Instead, the edge capabilities may be distributed across multiple edge nodes and systems, which may collaborate to help each other to provide the desired services. In other words, an edge system can include any number of virtualized services and/or data stores that are spread across the distributed edge nodes. This may include a master-slave configuration, publish-subscribe configuration, or peer-to-peer configuration.

Low power and Lossy Networks (LLNs), e.g., certain sensor networks, may be used in a myriad of applications such as for “Smart Grid” and “Smart Cities.” A number of challenges in LLNs have been presented, such as:
1) Links are generally lossy, such that a Packet Delivery Rate/Ratio (PDR) can dramatically vary due to various sources of interferences, e.g., considerably affecting the bit error rate (BER);
2) Links are generally low bandwidth, such that control plane traffic must generally be bounded and negligible compared to the low rate data traffic;
3) There are a number of use cases that require specifying a set of link and node metrics, some of them being dynamic, thus requiring specific smoothing functions to avoid routing instability, considerably draining bandwidth and energy;
4) Constraint-routing may be required by some applications, e.g., to establish routing paths that will avoid non-encrypted links, nodes running low on energy, etc.;
5) Scale of the networks may become very large, e.g., on the order of several thousands to millions of nodes; and
6) Nodes may be constrained with a low memory, a reduced processing capability, a low power supply (e.g., battery).

In other words, LLNs are a class of network in which both the routers and their interconnect are constrained: LLN routers typically operate with constraints, e.g., processing power, memory, and/or energy (battery), and their interconnects are characterized by, illustratively, high loss rates, low data rates, and/or instability. LLNs are comprised of anything from a few dozen and up to thousands or even millions of LLN routers, and support point-to-point traffic (between devices inside the LLN), point-to-multipoint traffic (from a central control point to a subset of devices inside the LLN) and multipoint-to-point traffic (from devices inside the LLN towards a central control point).

An example implementation of LLNs is an “Internet of Things” network. Loosely, the term “Internet of Things” or “IT” may be used by those in the art to refer to uniquely identifiable objects (things) and their virtual representations in a network-based architecture. In particular, the next frontier in the evolution of the Internet is the ability to connect more than just computers and communications devices, but rather the ability to connect “objects” in general, such as lights, appliances, vehicles, HVAC (heating, ventilating, and air-conditioning), windows and window shades and blinds, doors, locks, etc. The “Internet of Things” thus generally refers to the interconnection of objects (e.g., smart objects), such as sensors and actuators, over a computer network (e.g., IP), which may be the Public Internet or a private network. Such devices have been used in the industry for decades, usually in the form of non-IP or proprietary protocols that are connected to IP networks by way of protocol translation gateways. With the emergence of a myriad of applications, such as the smart grid advanced metering infrastructure (AMI), smart cities, and building and industrial automation, and cars (e.g., that can interconnect millions of objects for sensing things like power quality, tire pressure, and temperature and that can actuate engines and lights), it has been of the utmost importance to extend the IP protocol suite for these networks.

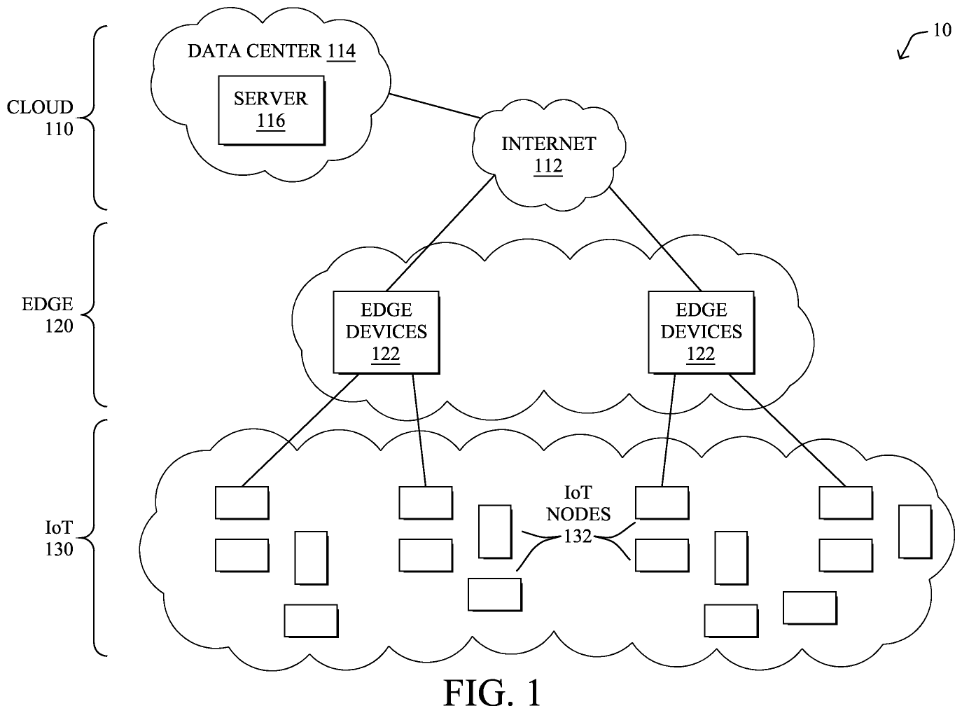

FIG. 1 is a schematic block diagram of an example simplified computer network 100 illustratively comprising nodes/devices at various levels of the network, interconnected by various methods of communication. For instance, the links may be wired links or shared media (e.g., wireless links, wired links, etc.) where certain nodes, such as, e.g., routers, sensors, computers, etc., may be in communication with other devices, e.g., based on connectivity, distance, signal strength, current operational status, location, etc.

Specifically, as shown in the example IoT network 100, three illustrative layers are shown, namely cloud layer 110, edge layer 120, and IoT device layer 130. Illustratively, the cloud layer 110 may comprise general connectivity via the Internet 112, and may contain one or more datacenters 114 with one or more centralized servers 116 or other devices, as will be appreciated by those skilled in the art. Within the edge layer 120, various edge devices 122 may perform various data processing functions locally, as opposed to datacenter/cloud-based servers or on the endpoint IoT nodes 132 themselves of IoT device layer 130. For example, edge devices 122 may include edge routers and/or other networking devices that provide connectivity between cloud layer 110 and IoT device layer 130. Data packets (e.g., traffic and/or messages sent between the devices/nodes) may be exchanged among the nodes/devices of the computer network 100 using predefined network communication protocols such as certain known wired protocols, wireless protocols, or other shared-media protocols where appropriate. In this context, a protocol consists of a set of rules defining how the nodes interact with each other.

Those skilled in the art will understand that any number of nodes, devices, links, etc. may be used in the computer network, and that the view shown herein is for simplicity. Also, those skilled in the art will further understand that while the network is shown in a certain orientation, the network 100 is merely an example illustration that is not meant to limit the disclosure.

Data packets (e.g., traffic and/or messages) may be exchanged among the nodes/devices of the computer network 100 using predefined network communication protocols such as certain known wired protocols, wireless protocols (e.g., IEEE Std. 802.15.4, Wi-Fi, Bluetooth®, DECT-Ultra Low Energy, LoRa, etc.), or other shared-media protocols where appropriate. In this context, a protocol consists of a set of rules defining how the nodes interact with each other.

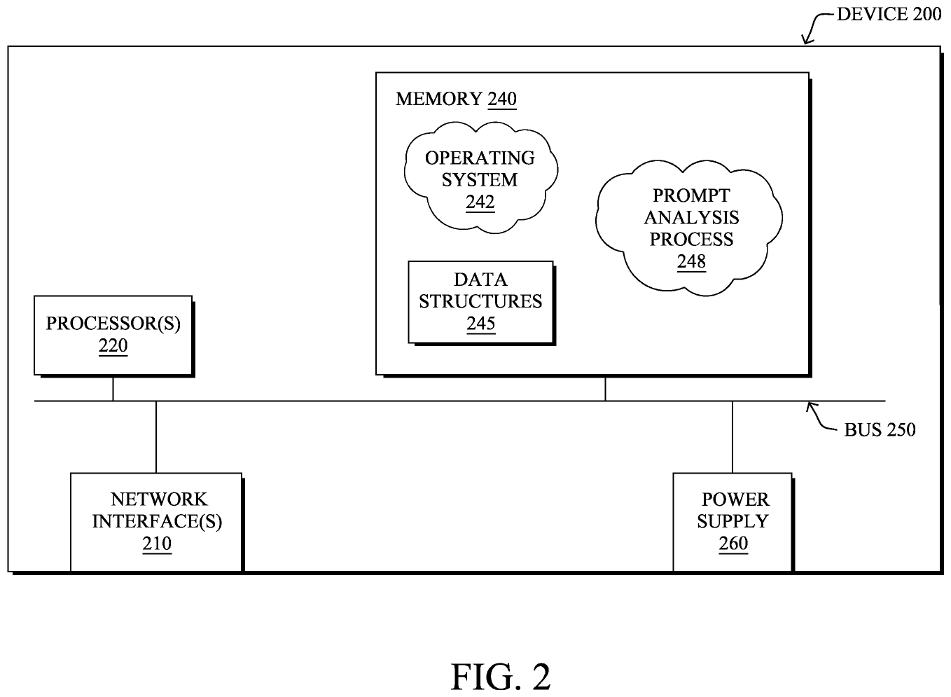

FIG. 2 is a schematic block diagram of an example node/device 200 (e.g., an apparatus) that may be used with one or more implementations described herein, e.g., as any of the nodes or devices shown in FIG. 1 above or described in further detail below. The device 200 may comprise one or more network interfaces 210 (e.g., wired, wireless, etc.), at least one processor 220, and a memory 240 interconnected by a system bus 250, as well as a power supply 260 (e.g., battery, plug-in, etc.).

The network interfaces 210 include the mechanical, electrical, and signaling circuitry for communicating data over physical links coupled to the network 100. The network interfaces may be configured to transmit and/or receive data using a variety of different communication protocols. Notably, a physical network interface 210 may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the implementations described herein. The processor 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software components may comprise a as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

In various implementations, as detailed further below, prompt analysis process 248 may include computer executable instructions that, when executed by processor(s) 220, cause device 200 to perform the techniques described herein. To do so, in some implementations, prompt analysis process 248 may utilize machine learning. In general, machine learning is concerned with the design and the development of techniques that take as input empirical data (such as network statistics and performance indicators), and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a,b,c such that the number of misclassified points is minimal. After this optimization phase (or learning phase), the model M can be used very easily to classify new data points. Often, M is a statistical model, and the cost function is inversely proportional to the likelihood of M, given the input data.

In various implementations, prompt analysis process 248 may employ one or more supervised, unsupervised, or semi-supervised machine learning models. Generally, supervised learning entails the use of a training set of data, as noted above, that is used to train the model to apply labels to the input data. For example, the training data may include sample telemetry that has been labeled as being indicative of an acceptable performance or unacceptable performance. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that prompt analysis process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), generative adversarial networks (GANs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, prompt analysis process 248 may also include one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, in the context of network assurance, prompt analysis process 248 may use a generative model to generate synthetic network traffic based on existing user traffic to test how the network reacts. Example generative approaches can include, but are not limited to, generative adversarial networks (GANs), large language models (LLMs), other transformer models, and the like.

As noted above, the recent breakthroughs in large language models (LLMs), such as ChatGPT and GPT-4, represent new opportunities across a wide spectrum of industries. More specifically, the ability of these models to follow instructions now allow for interactions with tools (also called plugins) that are able to perform tasks such as searching the web, executing code, etc. In addition, agents can be written to perform complex tasks by chaining multiple calls to one or more LLMs. For instance, in the context of computer networks, LLMs could be configured to generate command line interface (CLI) commands for networking devices, scripts or other code for execution by specific nodes in the network, configuration changes for certain endpoints or networking devices, or the like. Other tasks may relate to reporting on captured telemetry or sensor measurements, summarizing that data, or making inferences based on the data. Further tasks may even entail providing some form of control over endpoints in the network (e.g., asking a smart thermostat to adjust its setpoint temperature, etc.).

While LLMs are quite capable of performing a myriad of tasks, they are also typically considerably large and complex, making them ill-suited for deployment to singular devices for execution. Thus, in many IoT and other network deployments, LLMs are precluded from being executed at the edge, instead being cloud-hosted. This reliance on a cloud-hosted LLM means both increased WAN bandwidth utilization, as well as increased processing latency, as traffic needs to be conveyed between the local site and the cloud. One observation herein, though, is that many IoT and other deployments do not require the capabilities of a full-scale LLM and that they only need to perform a relatively small, discrete set of tasks.

### —Language Model Specialization Via Prompt Analysis—

The techniques herein allow for the creation of specialized language models (e.g., LLMs) based on the operations of a full-scale LLM that is capable of performing any number of different tasks. In various implementations, each specialized model may be capable of performing only a singular, discrete task of that of the full-scale LLM, or a small subset thereof. As a result, the specialized models may be small enough for execution further into the network, such as by edge devices, networking devices, or the like.

Illustratively, the techniques described herein may be performed by hardware, software, and/or firmware, such as in accordance with prompt analysis process 248, which may include computer executable instructions executed by the processor 220 (or independent processor of interfaces 210) to perform functions relating to the techniques described herein.

Specifically, according to various implementations, a device obtains prompt-response pairs of prompts for input to a language model and their corresponding responses from the language model. The device classifies each of the prompt-response pairs as relating to one or more tasks. The device trains a specialized language model using the prompt-response pairs related to a particular task. The device causes the specialized language model to be deployed for use to perform the particular task

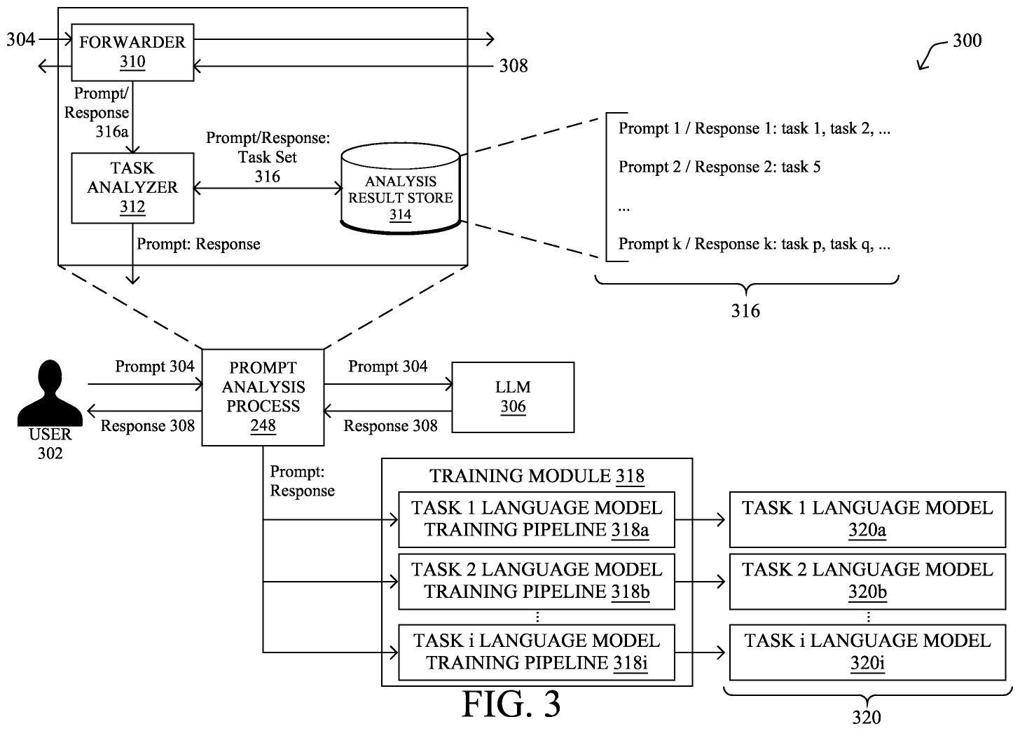

Operationally, FIG. 3 illustrates an example architecture for language model specialization via prompt analysis, according to various implementations. At the core of architecture 300 is prompt analysis process 248, which may be executed by a controller for a network, a device in a local network (e.g., an edge device), a device in a data center or cloud deployment, or another device in communication therewith.

As shown, prompt analysis process 248 may include any or all of the following components: a forwarder module 310, a task analyzer 312, an analysis results store 314, and/or a training module 318. As would be appreciated, the functionalities of these components may be combined or omitted, as desired. In addition, these components may be implemented on a singular device or in a distributed manner, in which case the combination of executing devices can be viewed as their own singular device for purposes of executing prompt analysis process 248.

During execution, prompt analysis process 248 may operate as an intermediary between a user 302 that interacts with a user interface (e.g., a keypad, a touch screen device, a microphone, etc.) and an LLM 306 or other language model. For instance, LLM 306 may be a language model that is cloud-hosted at a remote location from that of the endpoint operated by user 302. In some cases, LLM 306 may be integrated directly into prompt analysis process 248, as well (e.g., with prompt analysis process 248 providing an interface for LLM 306).

In general, LLM 306 may be a full-scale model trained to perform any number of tasks, such as tasks related to the monitoring or control of a computer network. To do so, LLM 306 may be capable of generating scripts or other code for execution, making application programming interface (API) calls, issuing command line interface (CLI) commands, providing control over an IoT actuator or sensor, summarizing or making inferences about captured telemetry data, or the like.

As would be appreciated, LLM 306 may perform its various tasks in response to prompts (e.g., conversational text) issued by user 302, such as prompt 304. In turn, LLM 306 may issue a response 308 to user 302. For instance, consider the case in which prompt 304 states “what is the reason for my Internet running slowly?” In such a case, LLM 306 may interact with a network controller and/or other networking nodes (e.g., routers, switches, etc.), to obtain information regarding the state of the network. In turn, LLM 306 may issue response 308 back to user 302 such as “there is an abnormal number of users attached to your wireless access point.”

In various implementations, forwarder module 310 of prompt analysis process 248 may capture both prompt 304 and response 308, to form a prompt-response pair 316a. For instance, forwarder module 310 may receive prompt 304 as input and forward it onward to LLM 306, retaining a copy of prompt 304 in the process. Similarly, forwarder 310 may receive response 308 from LLM 306 and forward it onward for presentation to user 302, retaining a copy of response 308 in the process. In turn, forwarder module 310 may associate prompt 304 with response 308, to form prompt-response pair 316a. For instance, forwarder module 310 may assess session identifiers associated with prompt 304 and response 308, timing information associated with them, their source and destinations (e.g., user 302), or the like, to determine that response 308 is associated with prompt 304.

As shown, prompt analysis process 248 may also include task analyzer 312 which is configured to classify each prompt-response pair, such as prompt-response pair 316a, as being related to one or more tasks for which LLM 306 has been trained to perform. In some implementations, task analyzer 312 may include a machine learning-based classifier trained to take prompt-response pairs as input and assign one or more task labels to that pair. For instance, in the above example of the user asking about their slow Internet connection, task analyzer 312 may determine that prompt-response pair 316a relates to the tasks of querying access point status information, querying available network bandwidth, etc.

After classifying prompt-response pair 316a, it may include it in a set 316 of prompt-response pairs for storage in analysis results store 314. As shown, each of the prompt-response pairs in set 316 may include one or more task tags assigned by task analyzer 312. For instance, a first prompt-response pair in set 316 may be associated with task 1, task 2, etc., a second prompt-response pair in set 316 may only be associated with task 5, while a kth prompt-response pair in set 316 may be associated with task p, task q, etc.

Since LLM 306 is a full-scale language model that is capable of performing a large set of different tasks (e.g., with respect to a target computer network), its size and resource requirements are likely too great for execution by a singular device in a local network, such as by an edge device/node. To this end, prompt analysis process 248 may also include training module 318 which is configured to generate compact language models that are able to perform discrete tasks from amongst the full set of tasks of which LLM 306 is capable of performing.

By way of example, training module 318 may include any number of language model training pipelines, such as a first training pipeline 318a, a second training pipeline 318b, etc., up to an i^{th} training pipeline 318i. During execution, each training pipeline of training module 318 may use the prompt-response pairs from set 316 tagged as relating to a particular task, to generate a corresponding language model 320 configured to perform that task. For instance, first training pipeline 318a may use the prompt-response pairs tagged with task 1 from analysis results store 314, to train a first language model 320a capable of performing task 1 in response to prompts from a user or other source. Similarly, second training pipeline 318b may train language model 320b using the prompt-response pairs from analysis results store 314 tagged with task 2, to perform task 2. This may continue for each task up to the i^{th} task, for which i^{th} training pipeline 318i may train language model 320i to perform that task. In this fashion, the smaller models can learn knowledge of the original model in an unsupervised manner.

While each of the language models 320 may be trained only to perform one discrete task, in some implementations, further implementations provide for them to perform a subset consisting of multiple tasks of which LLM 306 is capable of performing. Such functionality may be based on manual input from an administrator. In some cases, this functionality may also be based on how related two or more tasks are. For instance, if LLM 306 typically performs the same two tasks in succession (e.g., retrieving some telemetry data and performing a subsequent task based on that data), prompt analysis process 248 may instead opt to merge those tasks into a singular task (e.g., by having the classifier of task analyzer 312 merge the tasks into one task label).

Once prompt analysis process 248 has trained any or all of corresponding language model 320, it may cause those models to be deployed for performance of their respective tasks. For instance, prompt analysis process 248 may provide first language model 320a to a selected edge device for execution. In some implementations, the deployment may include any number of agents (e.g., endpoint agents, agents on the devices executing language models 320, etc.) that coordinate with one another to forward a given prompt to the appropriate language model 320 for processing.

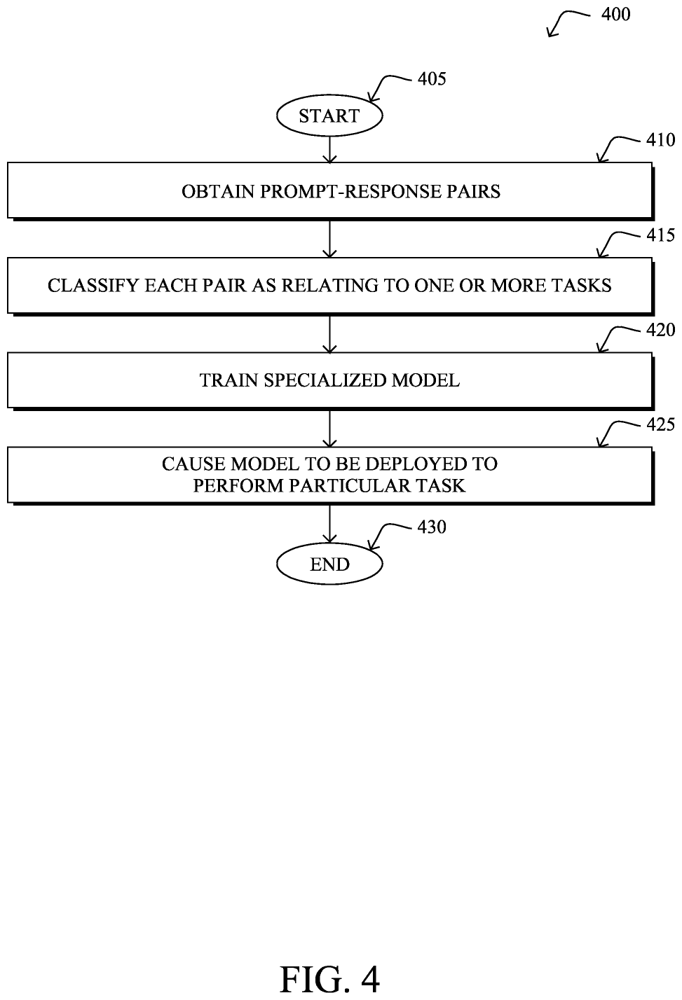

FIG. 4 illustrates an example simplified procedure (e.g., a method) for language model specialization via prompt analysis, in accordance with one or more implementations described herein. For example, a non-generic, specifically configured device (e.g., device 200), such as a router, firewall, controller for a network (e.g., an SDN controller or other device in communication therewith), server, or the like, may perform procedure 400 by executing stored instructions (e.g., prompt analysis process 248). The procedure 400 may start at step 405, and continues to step 410, where, as described in greater detail above, the device may obtain prompt-response pairs of prompts for input to a language model and their corresponding responses from the language model. In various implementations, the language model is a large language model trained to perform a plurality of tasks. In some cases, the device may obtain the prompt-response pairs by intercepting the prompts for input to the language model and their corresponding responses from the language model. In one implementation, the prompts for input to the language model are received via a user interface. In a further implementation, the language model is cloud-hosted.

At step 415, as detailed above, the device may classify each of the prompt-response pairs as relating to one or more tasks. In various implementations, the device may do so by using the prompt-response pairs as input to a machine learning-based classifier trained to apply one or more task labels to an input prompt-response pair. In further instances, the device classifies at least one of the prompt-response pairs as relating to a plurality of tasks that include the particular task.

At step 420, the device may train a specialized language model using the prompt-response pairs related to a particular task, as described in greater detail above. In some cases, the particular task comprises generating a configuration or script for use by a networking device. In some implementations, the device may train a plurality of language models that include the specialized language model to each perform one of the plurality of tasks.

At step 425, as detailed above, the device may cause the specialized language model to be deployed for use to perform the particular task. In various implementations, the specialized language model is deployed to an edge node for execution.

Procedure 400 then ends at step 430.

It should be noted that while certain steps within procedure 400 may be optional as described above, the steps shown in FIG. 4 are merely examples for illustration, and certain other steps may be included or excluded as desired. Further, while a particular order of the steps is shown, this ordering is merely illustrative, and any suitable arrangement of the steps may be utilized without departing from the scope of the implementations herein.

While there have been shown and described illustrative implementations that provide for language model specialization via prompt analysis, it is to be understood that various other adaptations and modifications may be made within the spirit and scope of the implementations herein. For example, while certain implementations are described herein with respect to using certain models for purposes of performing tasks such as generating CLI commands, making API calls, charting a network, and the like, the models are not limited as such and may be used for other types of tasks, in other implementations. In addition, while certain protocols are shown, other suitable protocols may be used, accordingly.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

1. A method comprising:
obtaining, by a device, prompt-response pairs of prompts for input to a language model and their corresponding responses from the language model;
classifying, by the device, each of the prompt-response pairs as relating to one or more tasks;
training, by the device, a specialized language model using the prompt-response pairs related to a particular task; and
causing, by the device, the specialized language model to be deployed for use to perform the particular task.

2. The method as in claim 1, wherein the language model is a large language model trained to perform a plurality of tasks.

3. The method as in claim 1, wherein obtaining the prompt-response pairs comprises:
intercepting, by the device, the prompts for input to the language model and their corresponding responses from the language model.

4. The method as in claim 1, wherein the specialized language model is deployed to an edge node for execution.

5. The method as in claim 1, wherein classifying each of the prompt-response pairs as relating to one or more tasks comprises:
using the prompt-response pairs as input to a machine learning-based classifier trained to apply one or more task labels to an input prompt-response pair.

6. The method as in claim 1, wherein the particular task comprises generating a configuration or script for use by a networking device.

7. The method as in claim 1, wherein the device classifies at least one of the prompt-response pairs as relating to a plurality of tasks that include the particular task.

8. The method as in claim 7, further comprising:
training, by the device, a plurality of language models that include the specialized language model to each perform one of the plurality of tasks.

9. The method as in claim 1, wherein the prompts for input to the language model are received via a user interface.

10. The method as in claim 9, wherein the language model is cloud-hosted.

11. An apparatus, comprising:
one or more network interfaces;
a processor coupled to the one or more network interfaces and configured to execute one or more processes; and
a memory configured to store a process that is executable by the processor, the process when executed configured to:
obtain prompt-response pairs of prompts for input to a language model and their corresponding responses from the language model;
classify each of the prompt-response pairs as relating to one or more tasks;
train a specialized language model using the prompt-response pairs related 10 to a particular task; and
cause the specialized language model to be deployed for use to perform the particular task.

12. The apparatus as in claim 11, wherein the language model is a large language model trained to perform a plurality of tasks.

13. The apparatus as in claim 11, wherein the apparatus obtains the prompt-response pairs by:
intercept the prompts for input to the language model and their corresponding responses from the language model.

14. The apparatus as in claim 11, wherein the specialized language model is deployed to an edge node for execution.

15. The apparatus as in claim 11, wherein the apparatus classifies each of the prompt-response pairs as relating to one or more tasks by:
using the prompt-response pairs as input to a machine learning-based classifier trained to apply one or more task labels to an input prompt-response pair.

16. The apparatus as in claim 11, wherein the particular task comprises generating a configuration or script for use by a networking device.

17. The apparatus as in claim 11, wherein the apparatus classifies at least one of the prompt-response pairs as relating to a plurality of tasks that include the particular task.

18. The apparatus as in claim 17, wherein the process when executed is further configured to:
train a plurality of language models that include the specialized language model to each perform one of the plurality of tasks.

19. The apparatus as in claim 11, wherein the prompts for input to the language model are received via a user interface.

20. A tangible, non-transitory, computer-readable medium storing program instructions that cause a device to execute a process comprising:
obtaining, by the device, prompt-response pairs of prompts for input to a language model and their corresponding responses from the language model;
classifying, by the device, each of the prompt-response pairs as relating to one or more tasks;
training, by the device, a specialized language model using the prompt-response pairs related to a particular task; and
causing, by the device, the specialized language model to be deployed for use to perform the particular task.
